(19) United States
(12) Patent Application Publication
(10) Pub. No.: US 2014/0334268 A1
(43) Pub. Date: Nov. 13, 2014

(54) METHODS FOR MODIFICATION OF INSECT BEHAVIOUR

(71) Applicant: Norma O'Hara, Airdrie (CA)

(72) Inventor: Norma O'Hara, Airdrie (CA)

(73) Assignee: Norma O'Hara, Airdrie, AB (CA)

(21) Appl. No.: 13/997,389

(22) PCT Filed: Dec. 9, 2011
(86) PCT No.: PCT/CA2011/001349

§ 371 Date: Dec. 16, 2013

Related U.S. Application Data
(60) Provisional application No. 61/427,347, filed on Dec. 27, 2010.

(51) Int. Cl. A01M 29/16; H04B 1/713; H04B 1/04

(52) U.S. Cl. CPC A01M 29/16; H04B 1/04; H04B 1/713
USPC 367/139; 375/295; 375/135; 375/303

(57) ABSTRACT

A method is described for emitting an insect behaviour modification signal to create a protected zone into which insect entry is minimized. The use of complex waveforms is described, emitted at frequencies from 150.000 Hz to 250.000 Hz. First and second waveforms are emitted at resonant frequencies to strengthen the protective effect. Further refinements include modulation of the transmitted signal, and frequency hopping of the transmitted signal.

### FIELD OF THE INVENTION

The present invention relates generally to methods for modifying insect behaviour and specific navigational flight paths, and methods for testing insect behaviour in order to evaluate said methods.

### BACKGROUND OF THE INVENTION

Insects such as mosquitoes, sand flies, black flies, gnats, moths, and migies are typically viewed as bothersome pests in first world countries. However, in many developing countries, certain insects are also responsible for transmission of diseases, having dire consequences on the human population in those areas.

Mosquitoes currently cause over four million human deaths per year due to their propagation of deadly diseases including malaria and West Nile virus. Black flies transmit tularaemia and onchocerciasis. Leishmaniasis, a disfiguring and often fatal parasitic disease, is spread by the bite of infected sand flies and currently affects approximately 12 million people worldwide. Although many initiatives are underway to control these diseases and prevent their spread in developing countries, there is currently no practical, effective way to avoid exposure to the insects carrying these diseases.

Current insect avoidance technologies include simple physical barriers such as nets for placement over beds and cribs, repellent sprays and cartridges, and high frequency emitting devices that are intended to simulate the signals emitted by insect predators.

With respect to mosquito avoidance, N, N-diethyl-m-toluamide (DEET) remains the gold standard for human personal repellents and is also effective against biting flies, chiggers, fleas, and ticks. Malathion is an insecticide commonly used for fogging to control mosquito populations. Permethrin is a broad-spectrum toxin used for killing insects and mites, but this method of insect control is nonspecific in that harmless non-target insects are also destroyed along with the mosquitoes. Permethrin may be applied directly to clothing to kill insects upon contact, however, caution should be exercised in using permethrin in combination with DEET repellents as severe cellular damage may result. It has been reported that thousands of Canadians suffer acute poisoning from insect spray/pesticides every year. In addition, many of these chemicals are suspected to increase the risk of cancer, neurological diseases, and organ damage in heavily exposed individuals. Moreover, as these control methods are weather-dependent, insect populations may be difficult to control if weather conditions are unfavourable.

Insect traps and electrocution devices have been developed to control insect populations within a specific zone, for example a residential year. In a typically system, an attractant such as ultraviolet light attracts insects towards an electrically charged grid. These devices are non-specific in that harmless non-target insects are also destroyed along with mosquitoes. Further, most of these devices are only mildly effective against mosquitoes and completely ineffective against biting flies. In addition, the by-products of insect electrocution include moth wing scale fragments and metal particles, which may result in serious allergic reactions or other health issues. Moreover, these systems are not portable, and therefore are not suitable for providing protection to a participant in outdoor recreation activities, such as hiking, camping, boating, fishing, etc.

With respect to mosquito deterrence, most recent signal technologies have been insect-mimetic. That is, they mimic detectable conditions in the natural environment that are suspected to deter biting female mosquitoes. For example, some technologies attempt to mimic the frequency of male mosquitoes (which are supposedly avoided by biting pregnant female mosquitoes) or other insect predators such as the dragonfly. These devices typically produce an audible whining sound and thus have proven annoying, as well as ineffective.

Eradication of insect species is not feasible or desirable, as insects are a critical part of the food chain in most environments. There must therefore be a balance between protection of human interests and maintenance of the environment and natural food chain.

It is known that many creatures, including migratory birds and turtles, use magnetic fields to orient themselves and navigate within their environment. Similarly, it is suspected that an insect's ability to navigate towards a source of food requires sensing of electromagnetic pathways within the environment. Recent evidence suggests that insects, birds, and potentially some animal species are able to sense the earth's magnetic lines, and may even perceive these pathways as patterns of color or light intensity superimposed on their natural surroundings.

The prior art includes widely varying examples of attempts to control insect activity through emission of signals. For example, U.S. Pat. No. 5,528,049 describes the emission of radiation frequencies and photonic waves to mimic natural insect attractant or repellent signals. U.S. Pat. No. 7,109,849 describes a device for emitting a mosquito dispersing pitch pattern, having a frequency in the range between the wing beat of a dragonfly and the wing beat frequency of a damselfly (20 to 40 Hz). U.S. Pat. No. 4,284,845 and U.S. Pat. No. 6,568,123 also describe devices for similarly emitting attractant or repellent signals.

There is no clear direction in the prior art as to which types of signals and which frequencies might be effective in controlling insect behaviour. Specifically, low frequencies in the prior art are taught to both attract mosquitoes towards a trap, and to repel mosquitoes.

To the Applicant's knowledge, none of the prior art signal devices have met with commercial success, and the teachings of the prior art have not been commercially useful.

### SUMMARY OF THE INVENTION

In accordance with a first aspect of the invention, there is provided a method for insect avoidance, comprising transmitting a first complex waveform at a frequency in the range of 180.000-250.000 Hz to establish a protected area free of one or more species of insect.

In one embodiment, the complex waveform is transmitted by amplitude modulation, frequency modulation, and/or frequency shift keying.

In another embodiment, the frequency is an oscillating frequency.

In a further embodiment, the complex waveform is transmitted at a frequency that is precise to the third decimal place.

In another embodiment, the first complex waveform is emitted from a speaker to establish a zone of insect avoidance about the speaker.

In another embodiment, the method further comprises transmitting a second waveform at a frequency in the range of 150.000 and 250.000 Hz. Further, the frequency of the second waveform may be resonant with the frequency of the first waveform.

In an embodiment, the frequency of the second waveform is an oscillating frequency. The frequencies of the first and second waveforms are oscillated together as pairs of resonant frequencies.

In various embodiments, the second wave may be a square waveform or complex waveform, and may be transmitted at a frequency that is precise to the third decimal place.

In a further embodiment, the second waveform is transmitted by amplitude modulation, frequency modulation, and/or frequency shift keying. The second waveform may be co-transmitted with the first waveform.

In another embodiment, the transmission mode of the second wave is varied from the transmission mode of the first wave.

In an embodiment, the first or second wave is transmitted with frequency hopping, which may be at 200-800 Hz.

In a further embodiment, the first or second wave is transmitted with frequency shift keying, which may be at 400-900 Hz.

In accordance with a second aspect of the invention, there is provided a method for determining a means for modifying the behaviour of a particular species of insect, the method comprising the steps of: transmitting a complex waveform at a frequency between 180.000 and 250.000 Hz in the presence of a plurality of insects of a particular species; and, observing the insects to determine whether an insect behaviour of interest is modified as a result of the signal transmission.

The method may further comprise co-transmitting a second waveform at a frequency resonant with the first frequency.

In various embodiments, the insect behaviour may be flying, feeding, biting, or mating.

In an embodiment, the step of observing comprises measuring the greatest distance from the signal transmitter at which behaviour is modified.

In an embodiment, the method further comprises modulating one or both of the first and second waveforms, by frequency shift keying from 400-900 Hz and/or by frequency hopping from 200-800 Hz.

In accordance with a third aspect of the invention, there is provided a method for enhancing the effectiveness of a first insect behaviour modification signal comprising transmitting the first signal with modulation by frequency shift keying.

In an embodiment, the method further comprises transmitting the first signal with frequency hopping.

In accordance with a fourth aspect of the invention, there is provided a method for enhancing the effectiveness of a first insect behaviour modification signal comprising transmitting the first insect avoidance signal with frequency hopping.

In an embodiment, the method further comprises transmitting the first insect behaviour modification signal with a second signal transmitted at a frequency resonant with the first signal.

In embodiments of the third or fourth aspect of the invention noted above, the first or second signal is transmitted at a frequency between 150.000 and 250.000 Hz. Further, the frequency shift keying is modulated at 400.000 to 900.000 Hz. Still further, frequency hopping may be carried out at 200.000 to 800.000 Hz.

The first and second signal may be transmitted with the same frequency hopping rate, and the first and second signal are paired and transmitted with the same or differing frequency shift keying rates.

In accordance with a fifth aspect of the invention, there is provided a system for use in protection from insects, the system comprising:
a waveform generator for generating complex waveforms
a signal transmitter for emitting the complex waveforms within an area in which protection from insects is desired;
a modulator for modulating the transmitter to emit a modulated signal;
frequency hopping spectrum transmitter for changing the carrier frequency in accordance with a predetermined hopping pattern.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1a-d are graphs of standard waveforms; and

FIG. 2a-j are graphs of sample complex waveforms.

### DETAILED DESCRIPTION

Generally, methods are provided for controlling insect behaviour. Further, methods are provided for use in determining or identifying signals useful in the modification of insect behaviour. Still further, methods for refining and enhancing insect behaviour modification signals are provided, for the purposes of enhancing insect control.

It is believed that the ability of insects to navigate within their environment requires the sensing of electromagnetic impulses and/or other signals naturally present in the environment. For example, a mosquito may navigate towards a blood source by sensing the carbon dioxide in the environment, and travelling along electromagnetic waves naturally present within the environment towards the carbon dioxide source. Thus, the electromagnetic field present in the natural environment may provide pathways for use in navigation by an insect. Thus, if such naturally occurring signals can be modified or cancelled within the environment, the ability of insects to navigate and will be unable to navigate within the protected zone.

### Protected Zone

An appropriate signal, applied to the natural environment, may distort, cancel, or otherwise disrupt the natural electromagnetic field used by the insect, for example for flight navigation. As a result, the insect becomes unable to function within a certain radius of such signal. When nearing this radius, therefore, the insect becomes disoriented and therefore must avoid the protected zone. It is believed that such a signal (such as a sound wave of specific shape, frequency, etc.) may be applied to an environment to cause destructive interference with the natural electromagnetic field, disturbing the natural pathways involved with insect navigation.

A protective zone formed by application of an insect control signal is independent of the number of insects outside the radius of the protective signal. In some circumstances, the effectiveness of the signal is impacted by certain environmental conditions (such as high humidity, winds, or pollution). However, laboratory testing is a reasonable means to determine of an effective signal, with further refinements made in the field upon further testing to accommodate for varying conditions and to increase the radius or strengthen the impact of the signal for real world use. Notably, the signal does not appear to directly harm the insects, leaving this level of the food chain intact.

### Signal Characteristics

The emission of one or more signals oscillating at frequencies generally between 100.000 to 300.000 Hz will form a protected zone about the emission source to cancel one or more electromagnetic signals within the natural environment. Alternatively, one or more frequencies known to be effective in modifying a particular behaviour of a particular insect may be transmitted to the environment as a single signal, or in oscillation with other effective signals.

As many fields and frequencies are naturally present within the environment, with various insects using different frequencies for specific purposes, the method may be directed very precisely to one particular insect or effect by selecting signals that are insect-specific and/or behaviour specific. For example, interruption of mosquito flight navigation may still permit dragonflies to enter the protected zone. It is expected that there may be some response overlap between species that are closely related or are similar in size. The frequency, acoustic wave shape, and number of signals emitted within the protected zone may all be varied to achieve a suitable insect control signal. The present description provides suitable teachings regarding the ranges of these parameters such that an appropriate signal or set of signals suitable to allow avoidance of a particular insect may be identified within reasonable efforts.

In some circumstances, a protected zone may be established using a single signal, emitted at a particular frequency. With only a single signal, the modification may be slight and unreliable, depending on atmospheric conditions and the relative efficacy of the signal generally. In order to strengthen the effects of such a signal, a second signal may be emitted with the first signal at a frequency that is resonant with the first signal. This, as well as the selection of more complex waveforms in at least one of the signals, will improve effectiveness of the protected zone, providing more robust cancellation or modification of insect behaviour. Moreover, adjustments may be made to strengthen the protected zone by modulating the signal, for example using frequency shift keying and frequency hopping to aid in resonance and interaction of the waves. These factors are discussed below.

### Waveforms

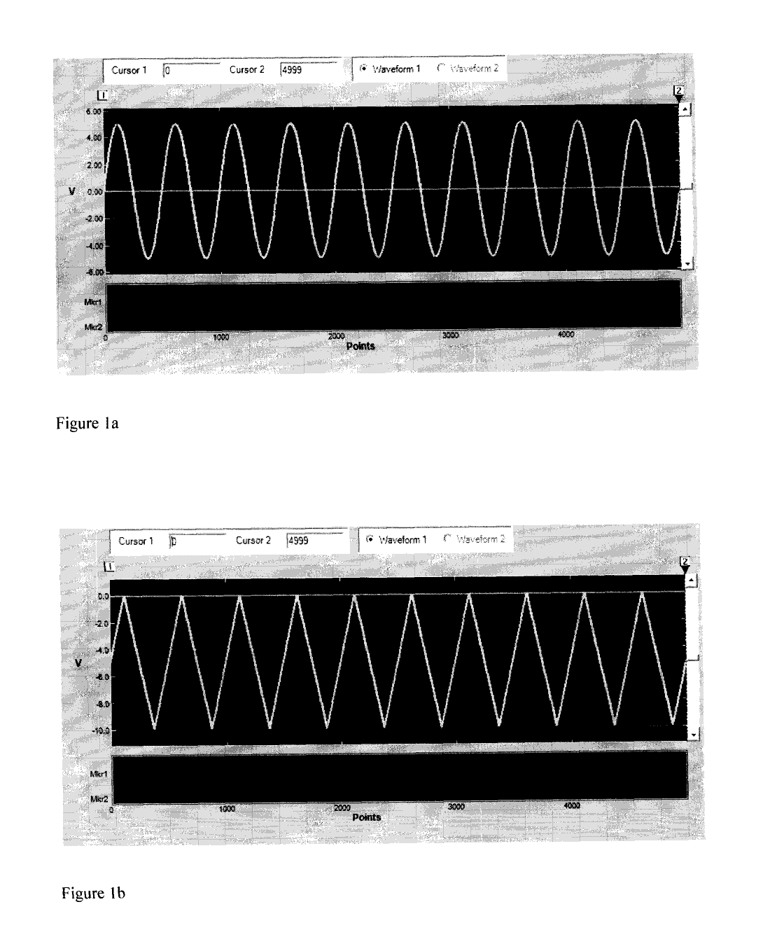

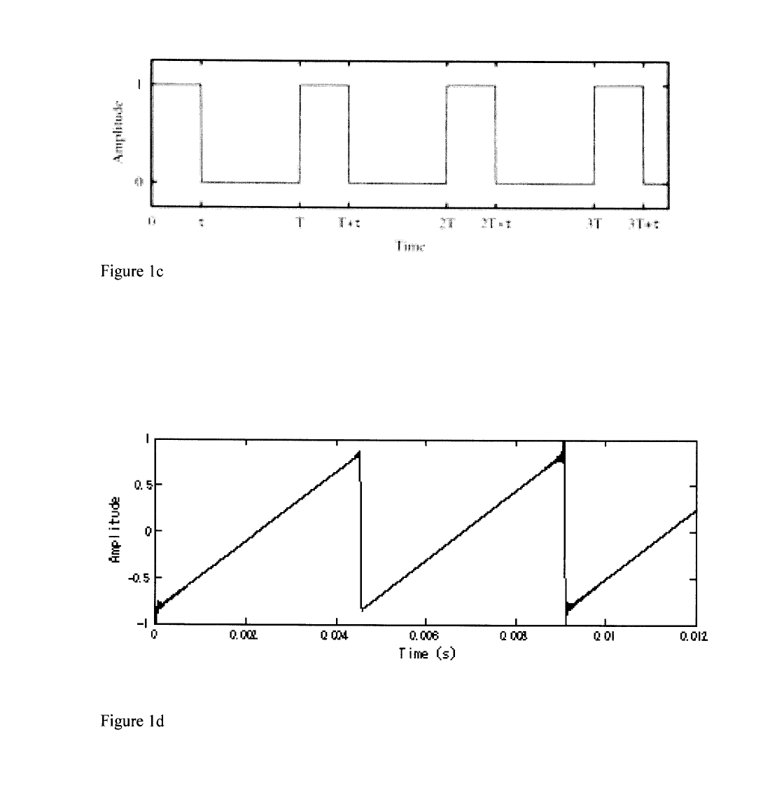

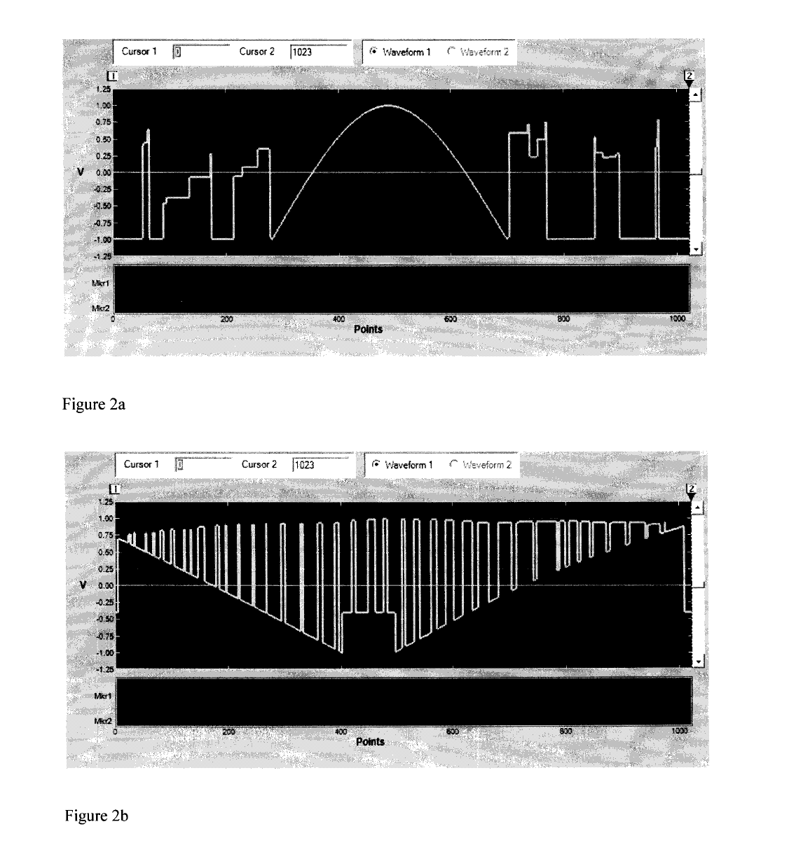

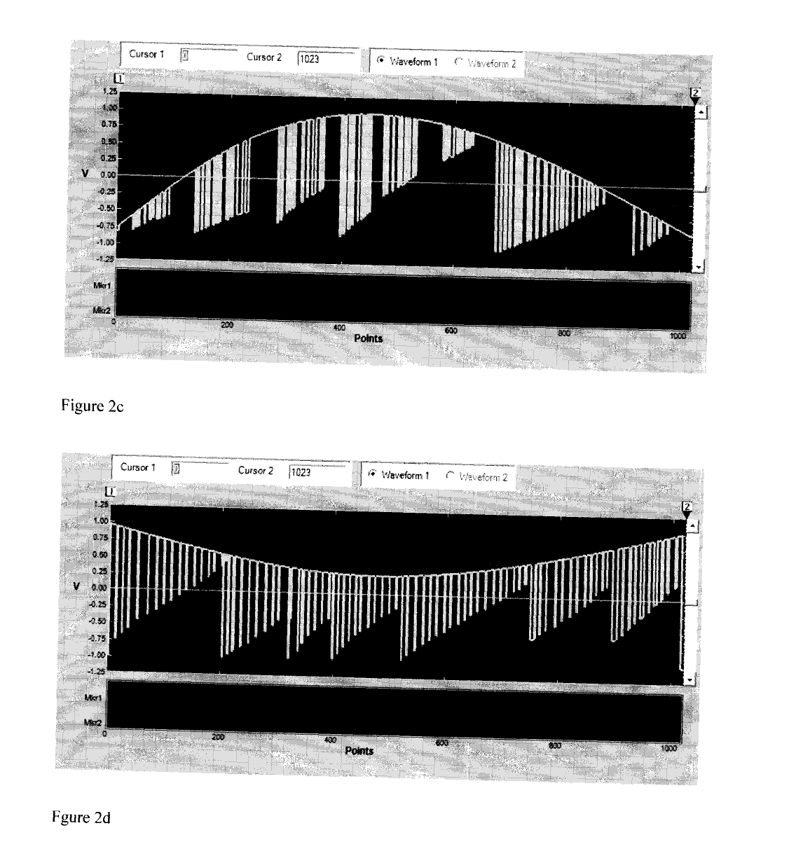

A complex shape of the waveform will assist in generating an appropriate insect modification signal. That is, it has been observed that insect modification signals are generally made more effective by increasing the complexity of the wave shape. Notably, by increasing the irregularity, or erratic nature of the wave shape, it appears that insect adaptation to the signal can be minimized. For example, a sine wave is smooth, regular, and predictable in its shape and effect on the environment. Application of a sine wave signal therefore provides minimal impact on an insect, and the insect is able to adapt and recommence the unwanted behaviour within the protected zone after only a short period of disruption. Similarly, the typical sawtooth, square wave, triangular wave, etc. are also of limited use as insect modification signals, particularly when used alone (although these do provide greater effect than the sine wave shape). Such regular wave shapes are shown in FIG. 1 a-d, and these wave shapes have been only minimally effective in generating suitable insect modification signals.

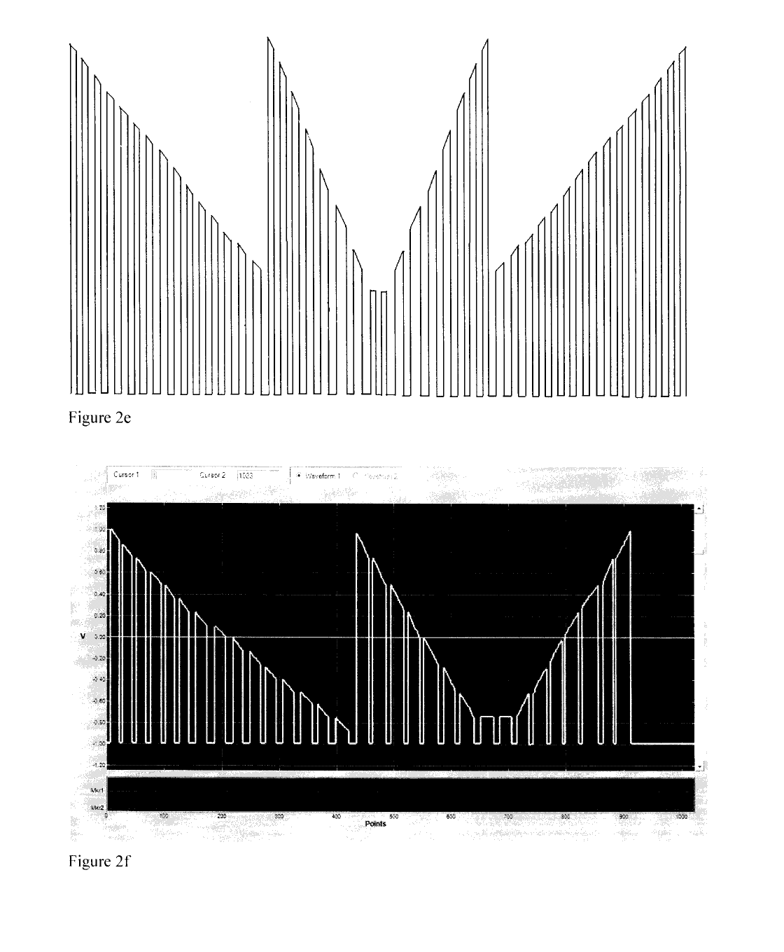

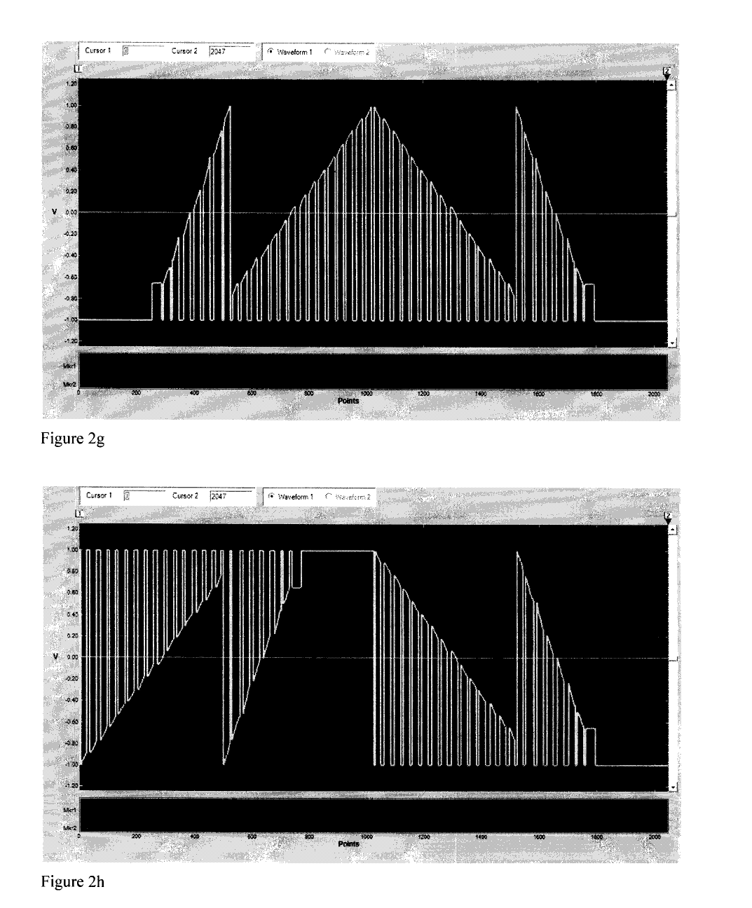

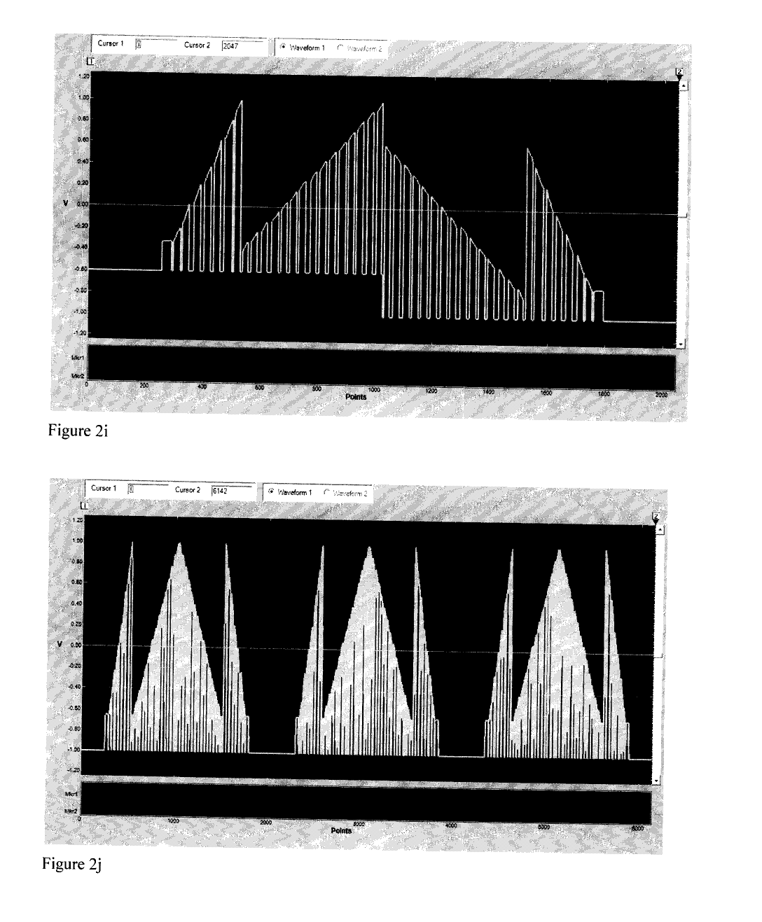

The complex wave shapes shown in FIG. 2a-j may be generally described as being composed from a number of wave segments. For example, with reference to any one of the waves shown, segmenting the wave into sections (ie. from one rise to the next) results in as many as one hundred wave segments or more. In viewing the wave segments, it is noted that most are generally similar to adjacent or nearby wave segments, providing gradual fluctuations in the overall waveform, with some notable segment exceptions. These exceptions for example a wave segment with a significant plateau after a rise or fall, or a segment with a greatly exaggerated peak or trough compared to surrounding segments provide noticeable irregularities in the overall shape of the complex wave. Similarly, these irregularities in the emitted signal provide disturbance or inconsistency in the environment, for example preventing a mosquito from recognizing the signals or pathways required for flight navigation. In any event, a great degree of complexity and irregularity in the emitted wave shape increases the effect of behavioural modification provided by the signal.

Complex waves may be used at varying frequencies to modify various insect behaviours in various species. The complex waveforms may be created by additive synthesis. To date, tested waveforms have been created using a Tektronix™ waveform generator, which allows the user to control the complexity and design of the waveform. The resulting signals may be emitted at any desired frequency.

### Frequency

Insect behaviour modification has been noted by the Applicants when signals are emitted in the range of 100.000 Hz to 300.000 Hz.

With respect to insect flight, and particularly mosquito avoidance, signals (which may be audible or inaudible) emitted in combination at frequencies between 150.000 Hz-250.000 Hz have been effective in establishing a protected zone, preventing mosquito entry into the zone. As discussed above, a more robust zone of protection will typically be provided when the wave shape is increasingly complex.

The desired complex wave shape is emitted (with or without accompanying audible sound) either constantly at a specific frequency, or oscillating across a range of frequencies (or at least across a portion of this range). If certain frequencies within the oscillating range are known to be ineffective through testing, these can be removed from the oscillating set to improve the effectiveness of the oscillating signal.

It is believed that insects are highly sensitive to electromagnetic signals, and respond more effectively to very precise signals. Specifically, testing to date in mosquito protection has shown that when the signal is precise to the third decimal place, a more effective mosquito-free zone may be generated by application of a suitable insect control signal. It is expected that a more precise signal may produce similar or possibly more effective results, while a precision of only two decimal places has been less effective.

### Dual Signal Emission

The Applicant has found that a protected zone may be enhanced when two co-operative signals are emitted together, to establish the protected zone. While two independently effective frequencies emitted together may improve the overall protection in linear fashion, synergistic improvements in protection are noted when the second signal is emitted at a frequency that resonates with the first frequency. For example, the second signal may be a harmonic or subharmonic frequency of the first signal frequency, or a near-harmonic or near-subharmonic frequency of the first signal. The two signals may be additive to cause constructive interference or destructive interference in certain wave segments. The signals may be different or identical in waveform.

Further, the emission of resonant paired signals has been shown during testing to enhance mosquito protection by more effectively preventing entry into the zone. For example, when a single signal is emitted, mosquito protection may be effective, but insects may enter a few inches into the protected zone prior to exiting. By contrast, when an additional resonant signal is also emitted, protection is more complete and the boundaries of protection appear to be more definite. Consequently, the second signal appears to strengthen the destructive interference (cancellation) of the natural flight pathways used by the mosquito, or otherwise creates a notable disturbance in the natural environment that cannot be penetrated by the insect.

Typically, with respect to protection from mosquitoes, first and second signals of complex wave shape, each in the range of 150.000 Hz to 250.000 Hz, may be used to generate a zone of protection from mosquitoes. To date, zones of protection up to eight feet in radius have been achieved. Variations in the frequency or complexity of the waveforms will change the radius of protection achieved. Addition of further signals (eg. a third and/or fourth signal) may enhance the protection, while elimination of one of the two signals would generally be expected to reduce the radius of protection.

While a minimal radius of control may provide suitable protection, for example from mosquito bites, the user may wish to maximally extend the zone of protection. For example, a wider radius may be desired to avoid closely buzzing insects or to protect a nearby child, or to accommodate use in a range of weather or atmospheric conditions. Accordingly, such signals may be adjusted/determined.

Similarly, departure from a highly complex and erratic wave shape to a more regular shape is expected to reduce the protective effect, even when emitted at an otherwise suitable frequency. Addition of a third signal may enhance effect. Thus, the factors of wave shape, frequency, and resonance all contribute to the degree of protection afforded.

When oscillating the frequencies of dual waves across an environment, the waves may be oscillated together as resonant pairs. The set of frequency pairs for oscillation may be defined based on testing of single waves, where an effective single wave is used to calculate a corresponding resonant frequency for a second wave, to create each pair. Such pairs may be by mathematical calculation in accordance with known methods.

It will be apparent to those skilled in the art that in some embodiments, co-transmission of dual resonant waves as discussed herein will result in the emission of an additive wave having certain characteristics and a certain combined frequency. Those skilled in the art may be able to generate such an additive or resultant wave using techniques known in the art, and such reverse engineering is specifically contemplated herein and encompassed within the scope of the present teachings.

### Refinement of Signal Transmission

The insect behaviour modification signal is modulated when transmitted to the environment, for example by frequency modulation, amplitude modulation, or frequency shift keying. Such modulation methods for audio signals have been well described previously. Similar to the above-discussed concept of increasing avoidance by increasing the complexity of the wave, increasing the disturbance or irregularity in the transmission also improves avoidance. This increased complexity and unpredictability is thought to impair the insect's ability to adapt to the signal.

### Frequency Shift Keying

Notably, the Applicant has found that when the carrier wave is modulated by frequency shift keying, a stronger impact on insect behaviour may be observed. As is well known in communication applications, frequency shift keying (FSK) shifts the carrier frequency of the transmitter. Unlike FM modulation, FSK shifts the frequency between fixed points. While FSK in communication applications generally has the disadvantage of requiring elaborate receiving gear, this is not a problem in the present system, as no receiver is required.

Frequency shift keying within the range of 400-900 Hz has been found to be particularly effective in modulating suitable insect avoidance signals. Testing to date has found that further improvements can be achieved by independent frequency shift keying for each signal emitted.

### Frequency Hop

Further complicating the transmission by varying the carrier frequency according to a hopping pattern (frequency hop) provides additional complexity in the impact of the signal on the environment, and more robust modification of insect behaviour. That is, insect entry into a zone in which an insect avoidance signal is emitted is more consistently prevented when the signal is transmitted with a frequency hop.

Frequency hopping at a rate of 200 Hz to 800 Hz has been found to be particularly effective in strengthening suitable insect avoidance signals. Testing to date has found that the frequency hop for dual resonant signals may be carried out at the same rate with both signals with notable impact.

It is believed that hop modulation of the emitted waves further distorts the earth's existing electromagnetic key lines (used by the insect) by creating additional air movement within the dual wave formation. The introduction of a low Hz hop modulation provides further complexity to the emitted waves, maintains/enhances air movement within the protected zone, and thereby allows the emitted waves to keep remain intact for an extended range. Notably, light winds have lesser effect on the radius of protection provided when frequency hopping is utilized.

Other Parameters

Variations in environmental conditions may affect the signal in some embodiments. For example, if the waveform does not have sufficient irregularity and provides only a minimal radius of protection, the environmental conditions may result in further minimization of the radius of protection. For example, surrounding minerals, atmospheric pressure, etc. may affect the signal or the insects to some degree. It is expected that an insect may be able to operate within several closely related frequency ranges to accommodate changes in the natural environment. Accordingly, it is conceivable that the protected zone may benefit from refinement of the signal from one environment to another, however testing to date indicates that such refinement is not necessary as the environment has had negligible impact on the protected zone during testing.

Of further note is the observation that the inherent conductivity of the human body seems to extend the effective radius of protection. For example, when the protected radius from the emitter is three feet, one would expect that placement at the waist of the user could result in the user's head and feet remaining unprotected. However, in testing it appears that the radius instead extends approximately two feet from the user at any location on the user's body. This phenomenon of signal radius extension is believed to be a result of the inherent electrical conductivity of the human body.

### Methods for Determining Effective Insect Behaviour Modification Signals

Previous methods attempting to control insect behaviour have focussed on copying various insect adverse signals, sounds, or other stimuli. For example, signals attempting to mimic the presence of an insect predator or natural competitor have been developed. Such prior techniques, that mimic the presence of an insect adverse event (for example a signal that mimics the presence of a predator), tend to be high frequency signals, and of simple waveform. These have been ineffective for various reasons.

The present methods, in contrast, focus on the cancellation of signals within the natural environment that are innately detectable by insects, rather than by simulation of signals generated by another creature. This focus results in a unique method for experimentation to determine effective insect behaviour modification signals. Specifically, it is believed that each insect species is sensitive to specific natural signals or pathways in the environment, using these signals for flight navigation. The present research methods are directed to the determination of cancellation signals, to disable insect function within the physical area to which the cancellation signal is applied.

The Applicant has found that flight navigation signals used by various insects (for example, mosquitoes, sand flies, black flies, moths, and migies) tend to fall within a narrow range of frequencies, as noted above. Accordingly, flight cancellation signals may be determined for particular insects by applying test signals to an insect enclosure. For greater ease and certainty in detection of avoidance (inability to approach the signal), an insect attractant (such as carbon dioxide, blood, etc.) may also be placed at or near the signal source. Upon testing of an appropriate signal, insects will be unable to approach due to the presence of the flight cancellation signal, despite the presence of a strong attractant. Instead, the insects will tend to concentrate at the location that is closest to the attractant but not penetrated by the signal. Typically, this will allow the tester to determine the effective radius of the protected zone provided by the signal.

Signals within the ranges and parameters identified herein have been shown to be effective in flight disruption/avoidance of various species of insect, including mosquitoes, moths, sand flies, black flies, and horse flies. However, some degree of testing and refinement using the teachings provided herein should be undertaken to determine an effective avoidance signal for specific insects and conditions. Such reasonable testing is believed to be within the ability and expectation common to this art field.

When an effective signal frequency is identified, various complex waveforms may be tested, as may additional signals at varying resonant frequencies in combination. The effectiveness of the test signal may be enhanced by incorporating several of the features discussed herein.

When a second signal is added to the first complex wave, the second signal may be a resonant signal known to be effective, or may simply be an untested frequency that is presumed to be resonant with the first frequency.

Oscillation between paired resonant frequencies may provide further advantages when testing outdoors, as certain signals that have been effective in controlled environments may be less effective or more effective in varying weather and wind conditions. Thus, oscillating among a series of resonant frequency pairs known to be effective may provide greater real-world effectiveness than a single pair that tested effective in a laboratory setting. In some circumstances, simple random oscillation across the entire range frequencies may provide suitable protection under controlled conditions.

### EXAMPLES

For testing purposes, a Tektronix™ AFG 3022 waveform generator was used to emit the waveforms and generate the protected zones discussed herein. The frequency, voltage, amperage, phase, modulation, and load may all be controlled by the user.

Example settings, methods, waveforms and transmissions for use in determining effective mosquito avoidance are provided in the table below for illustrative purposes.

TABLE 1
Mosquito Protection

| | | |
|---|---|---|
| Frequency Wave 1 | 180.000 Hz-250.00 Hz | |
| Frequency Wave 2 | 150.000 Hz-250.000 Hz | |
| Waveform Wave 1 | Complex Waveform | (pics from |
| Waveform Wave 2 | Square Waveform | 1^{st} patent) |
| Modulation Wave 1 | AM, FM, FSK | |
| Modulation Wave 2 | AM, FM, FSK | |
| Speaker Size | ¼″-10″ | |
| FSK Frequency Wave 1 | 400 Hz-900 Hz | |
| FSK Frequency Wave 2 | 400 Hz-900 Hz | |
| OR | | |
| FM Frequency Wave 1 | 400 Hz-900 Hz | |
| FM Frequency Wave 2 | 400 Hz-900 Hz | |
| OR | | |
| AM Frequency Wave 1 | 400 Hz-900 Hz | |
| AM Frequency Wave 2 | 400 Hz-900 Hz | |
| HOP Wave 1 | 200 Hz-800 Hz | |
| HOP Wave 2 | 200 Hz-800 Hz | |
| Volts Wave 1 | −5 v-+5 v | (we use −1 v-+1 v) |
| Volts Wave 2 | −5 v-+5 v | (we use −1 v-+1 v) |
| Load Impedance Wave 1 | 0-50 | |
| Load Impedance Wave 2 | 0-50 | |
| Phase Wave 1 | 0-360.00 degrees | |
| Phase Wave 2 | 0-360.00 degrees | |
| Wave 1 | Sound Wave | |
| Wave 2 | Sound Wave | |

### Example 1

### Method for Testing Control Signals

Mosquitoes were trapped overnight in screened cages attached under a fan, using dry ice as a source of carbon dioxide (attractant). The mosquitoes were then transferred to a large (10×10) screened cage with a speaker at one end. Various test signals were generated by a Tektronix™ signal generator and emitted from the speaker.

Once a particular frequency was identified as effective, another set of mosquitoes were similarly tested in a 2×8 wood frame screened cage, with a speaker (and in some cases, attractant) at one end. The narrow cage and presence of attractant facilitates determination of the protected radius afforded by the signal.

For further testing, an additional set of mosquitoes are placed into a square gazebo 10×10 with a human subject inside. The subject holds the speaker emitting the test signal, to confirm that the presence of a human placed into the test area does not diminish the effectiveness of the test signal in preventing mosquito approach.

The above-described embodiments of the present invention are intended to be examples only. Alterations, modifications and variations may be effected to the particular embodiments by those of skill in the art without departing from the scope of the invention, which is defined solely by the claims appended hereto.

1. A method for insect avoidance comprising transmitting a first complex waveform at a frequency in the range of 180.000-250.000 Hz to establish a protected area free of one or more species of insect.

2. The method as in claim 1, wherein the complex waveform is transmitted by amplitude modulation, frequency modulation, or frequency shift keying.

3. The method as in claim 1, wherein the frequency is an oscillating frequency.

4. The method as in claim 1, wherein the complex waveform is transmitted at a frequency that is precise to the third decimal place.

5. The method as in claim 1, wherein the first complex waveform is emitted from a speaker to establish a zone of insect avoidance about the speaker.

6. The method as in claim 1, further comprising transmitting a second waveform at a frequency in the range of 150.000 and 250.000 Hz.

7. The method as in claim 6, wherein the frequency of the second waveform is resonant with the frequency of the first waveform.

8. The method as in claim 6, wherein the frequency of the second waveform is an oscillating frequency.

9. The method as in claim 8, wherein the frequencies of the first and second waveforms are oscillated together as pairs of resonant frequencies.

10. (canceled)

11. (canceled)

12. The method as in claim 6, wherein the second waveform is transmitted by amplitude modulation, frequency modulation, of frequency shift keying.

13. The method as in claim 6, wherein the second waveform is co-transmitted with the first waveform.

14. The method as in claim 11, wherein the transmission mode of the second wave is varied from the transmission mode of the first wave.

15. The method as in claim 1, wherein the first or second wave is transmitted with frequency hopping.

16. The method as in claim 15, wherein the frequency hopping I at 200-700 Hz.

17. The method as in claim 1, wherein the first or second wave is transmitted with frequency shift keying.

18. (canceled)

19. A method for determining a means for modifying the behaviour of a particular species of insect, the method comprising the steps of:
transmitting a complex waveform at a frequency between 180.000 and 250.000 Hz in the presence of a plurality of insects of a particular species;
observing the insects to determine whether an insect behaviour of interest is modified as a result of the signal transmission.

20. The method as in claim 19, further comprising co-transmitting a second waveform at a frequency resonant with the first frequency.

21. (canceled)

22. (canceled)

23. The method as in claim 19, further comprising modulating one or both of the first and second waveforms, by frequency shift keying from 400-900 Hz or by frequency hopping from 200-800 Hz.

24. (canceled)

25. (canceled)

26. A method for enhancing the effectiveness of a first insect behaviour modification signal comprising transmitting the first insect avoidance signal with frequency hopping.

27. The method as in claim 26, further comprising transmitting the first insect behaviour modification signal with a second signal transmitted at a frequency resonant with the first signal.

28. The method as in claim 26, wherein the first or second signal is transmitted at a frequency between 150.000 and 250.000 Hz.

29. (canceled)

30. The method as in claim 26, wherein the frequency hopping is carried out at 200.000 to 800.000 Hz.

31. (canceled)

32. (canceled)
